(19) United States
(12) Patent Application Publication
(10) Pub. No.: US 2026/0370910 A1
(43) Pub. Date: Nov. 19, 2026

(54) DISPLAY CONFIGURATION MANAGEMENT

(71) Applicant: INTERNATIONAL BUSINESS MACHINES CORPORATION, ARMONK, NY (US)

(72) Inventors: Robert Wilhelm, Hartford, AL (US); Derek Brewer, Bowling Green, OH (US); Adam Lee Davenport, Las Vegas, NV (US)

(21) Appl. No.: 19/206,892

(22) Filed: May 13, 2025

(51) Int. Cl. H04N 21/475; H04N 21/466; H04N 21/485

(52) U.S. Cl. CPC H04N 21/4756; H04N 21/466; H04N 21/4858

(57) ABSTRACT

Aspects of the present disclosure relate to display configuration management. Event data obtained from multiple accessed multi-media content items can be analyzed with respect to user data of a user to generate a significance score for respective ones of the multiple accessed multi-media content items, where the significance scores are generated for specific time windows of respective multi-media content items. The multiple accessed multi-media content items can be ranked based on the generated significance scores. A display reconfiguration action can be determined based on the ranking and further based on historical display configuration preferences of the user. The display reconfiguration action can be executed.

### BACKGROUND

The present disclosure relates generally to the field of computing, and in particular, to display configuration management.

Distinct multi-media content can be displayed on respective windows and/or displays simultaneously. Such content can include live streamed events and videos. Users can manage how content is displayed across their devices (e.g., a display configuration) by selecting displays or areas thereof (e.g., windows) for viewing specific items of content.

### SUMMARY

Aspects of the present disclosure relate to computer program products, systems, and methods for display configuration management. Event data obtained from multiple accessed multi-media content items can be analyzed with respect to user data of a user to generate a significance score for respective ones of the multiple accessed multi-media content items, where the significance scores are generated for specific time windows of respective multi-media content items. The multiple accessed multi-media content items can be ranked based on the generated significance scores. A display reconfiguration action can be determined based on the ranking and further based on historical display configuration preferences of the user. The display reconfiguration action can be executed.

The above summary is not intended to describe each illustrated embodiment or every implementation of the present disclosure.

### BRIEF DESCRIPTION OF THE DRAWINGS

The drawings included in the present disclosure are incorporated into, and form part of, the specification. They illustrate embodiments of the present disclosure and, along with the description, serve to explain the principles of the disclosure. The drawings are only illustrative of typical embodiments and do not limit the disclosure.

FIG. 1 is a high-level block diagram illustrating an example computer system and network environment that can be used in implementing one or more of the methods, tools, modules, and any related functions described herein, in accordance with embodiments of the present disclosure.

FIG. 2 is a block diagram illustrating an example network environment including a management system, in accordance with embodiments of the present disclosure.

FIG. 3 is a flowchart illustrating an example method display configuration management, in accordance with embodiments of the present disclosure.

FIG. 4 is a flowchart illustrating another example method display configuration management, in accordance with embodiments of the present disclosure.

FIG. 5 is a diagram depicting a first display configuration, in accordance with embodiments of the present disclosure.

FIG. 6 is a diagram depicting a display reconfiguration action that alters the first display configuration to a second display configuration, in accordance with embodiments of the present disclosure.

FIG. 7 is a diagram depicting another display reconfiguration action that alters the first display configuration to a third display configuration, in accordance with embodiments of the present disclosure.

While the embodiments described herein are amenable to various modifications and alternative forms, specifics thereof have been shown by way of example in the drawings and will be described in detail. It should be understood, however, that the particular embodiments described are not to be taken in a limiting sense. On the contrary, the intention is to cover all modifications, equivalents, and alternatives falling within the spirit and scope of the disclosure.

### DETAILED DESCRIPTION

Aspects of the present disclosure relate generally to the field of computing, and more particularly, to display configuration management. While the present disclosure is not necessarily limited to such applications, various aspects of the disclosure may be appreciated through a discussion of various examples using this context.

It is common for users to simultaneously view distinct pieces of multi-media content on different windows and/or displays simultaneously. Users can manually select viewing locations (e.g., specific windows, areas of displays, or full displays) that content should be displayed on using control commands. Thus, if a first content item (e.g., a first live streamed event) is currently more significant to a user than a second content item (e.g., a second live streamed event), the user can manually reconfigure their display configuration to prioritize viewing convenience of the first content item (e.g., set the first content item to a primary display and move the second content item to a secondary display).

However, it is a time consuming and tedious process for users to continuously manage content displayed within their environment. For example, as the significance of events within live streamed content frequently changes, users may be required to frequently change their display configuration in real-time to accommodate their viewing preferences. The continuous burden for users to manually reconfigure their display configuration detracts from the viewing experience. For example, without appropriate management of their display configuration, users may miss significant events that occur within specific items of content, view advertisements that they desire to skip, or otherwise have undesirable display configurations while multi-media content is playing. Solutions are needed to streamline user display configurations based on a real-time analysis of displayed content.

Aspects of the present disclosure relate to display configuration management. Event data obtained from multiple accessed multi-media content items can be analyzed with respect to user data of a user to generate a significance score for respective ones of the multiple accessed multi-media content items, where the significance scores are generated for specific time windows of respective multi-media content items. The multiple accessed multi-media content items can be ranked based on the generated significance scores. A display reconfiguration action can be determined based on the ranking and further based on historical display configuration preferences of the user. The display reconfiguration action can be executed.

Aspects of the present disclosure address the above-referenced complications and provide various improvements. Multiple items of multi-media content can be automatically reconfigured based on an analysis of event data occurring within respective items of multi-media content with respect to user data. This removes the need for a user to continuously manage their display configuration. This further enhances the user's viewing experience, enabling the user to view multi-media content significant to them without missing significant events and without viewing undesirable content (e.g., advertisements). Further, as the generation of significance scores can be completed using one or more trained machine learning models, computing efficiency and prediction accuracy of generating significance scores for ranking multi-media content is enhanced based on previous training iterations. Further, as the determination of display reconfiguration actions can be completed by one or more trained machine learning models, computing efficiency and prediction accuracy of determined display reconfiguration actions is enhanced based on previous training iterations.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

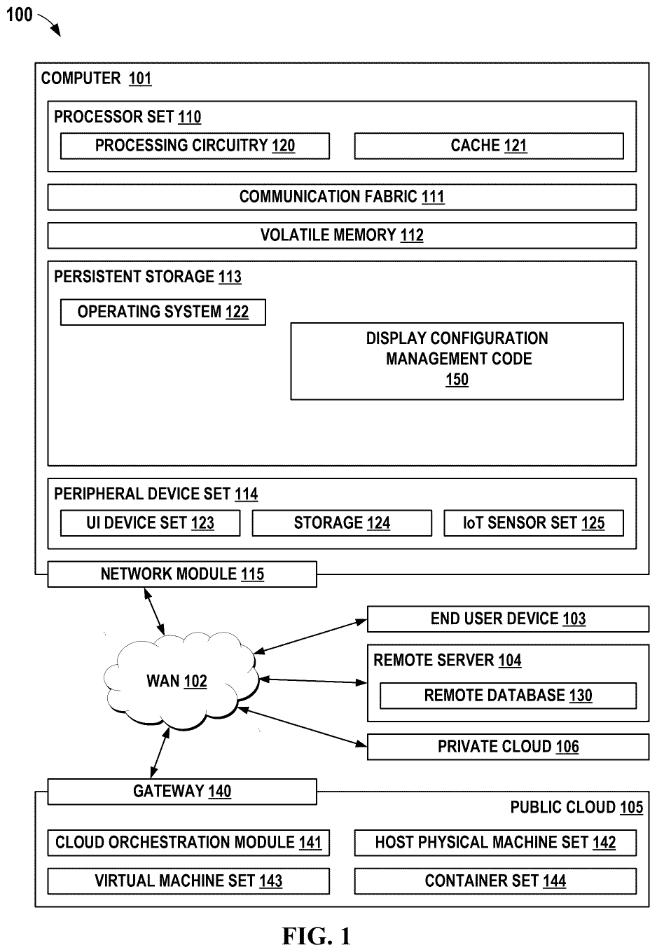

FIG. 1 is a high-level block diagram illustrating an example computing environment 100 that can be used in implementing one or more of the methods, tools, modules, and any related functions described herein, in accordance with embodiments of the present disclosure. Computing environment 100 contains an example of an environment for the execution of at least some of the computer code involved in performing the inventive methods, such as display configuration management code 150. In addition, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and display configuration management code 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some or all of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in display configuration management code 150 in persistent storage 113.

Communication fabric 111 includes the signal conduction paths that allow the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory 112 is characterized by random access, but this is not required unless affirmatively indicated. In computer 101, the volatile memory 112 is located in a single package and is internal to computer 101, but, alternatively or additionally, the volatile memory 112 may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in display configuration management code 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, mixed reality (MR) headset, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

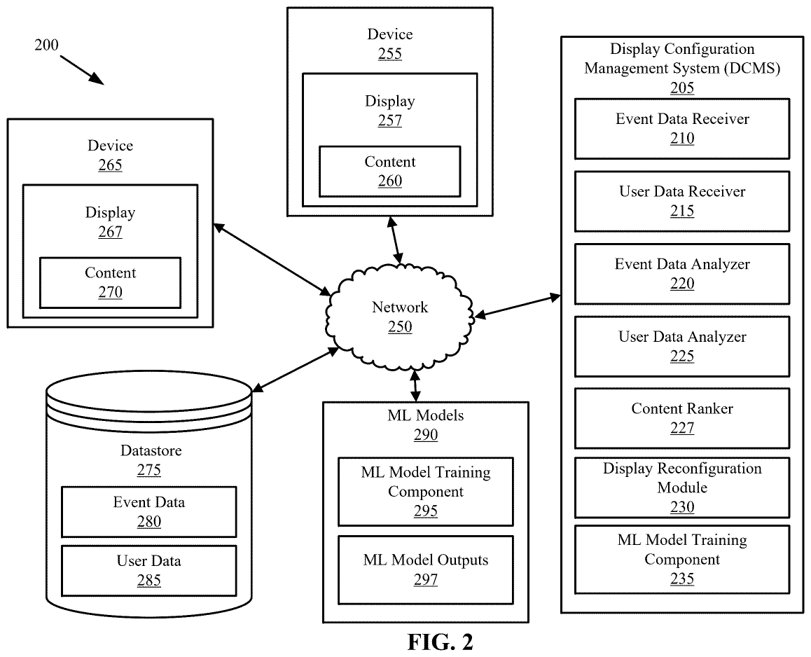

Referring now to FIG. 2, shown is a block diagram illustrating an example network environment 200 in which illustrative embodiments of the present disclosure can be implemented. The network environment 200 includes a display configuration management system (DCMS) 205, a device 255, a device 265, datastore 275, and ML models 290, each of which can be communicatively coupled for intercomponent interaction via a network 250. In embodiments, the network 250 can be the same as, or substantially similar to, WAN 102 of FIG. 1. In embodiments, the devices 255/265 and DCMS 205 can be the same as, or substantially similar to, computer 101, remote server 104, peripheral device set 114, and/or EUD 103 of FIG. 1. In embodiments, datastore 275 can be the same as, or substantially similar to, remote database 130, persistent storage 113, and/or storage 124 of FIG. 1.

The DCMS 205 can be configured to manage display configurations of users viewing multi-media content across multiple windows, displays, or areas thereof. A “display configuration” refers to a layout of multiple instances of multi-media content as displayed on one or more displays, windows, or other subsections of displays (e.g., a picture-in-picture display). DCMS 205 can be configured to access event data 280 and/or user data 285 for the purpose of managing display configurations of distinct users. Based on an analysis of the event data 280 associated with displayed content and/or user data 285 associated with specific users, the DCMS 205 can be configured to perform display reconfiguration actions to enhance user viewing experience. For example, the DCMS 205 can be configured to reconfigure the size and/or locations of windows displaying content, reconfigure displays that content is displayed on, reconfigure picture-in-picture viewing of content, open new content windows and/or displays, close content windows or displays, and/or provide display reconfiguration recommendations to users, among other potential display reconfiguration actions.

Devices 255 and 265 can be any suitable devices configured to display content 260 and 270 on respective displays 257 and 267 (e.g., monitors) or windows thereof. The devices 255 and 265 may be associated with a single user or multiple respective users. Though network environment 200 only depicts two devices 255 and 265, in embodiments, the network environment 200 can include any suitable number of devices. As an example, a first user may be viewing content 260 on device 255 (e.g., a smart phone) and content 270 on device 265 (e.g., a smart television). As another example, a first user may be viewing multiple items of content 260 on device 255 (e.g., multiple windows displaying respective items of content 260) and a second user may be viewing multiple items of content 270 on device 265 (e.g., multiple windows displaying respective items of content 270). However, any suitable number of devices having any suitable number of displays for displaying any suitable number of instances of content can be implemented without departing from the spirit and scope of the present disclosure.

The DCMS 205 includes an event data receiver 210, a user data receiver 215, an event data analyzer 220, a user data analyzer 225, a content ranker 227, a display reconfiguration module 230, and an ML model training component 235. The functionalities of the event data receiver 210, user data receiver 215, event data analyzer 220, user data analyzer 225, content ranker 227, display reconfiguration module 230, and ML model training component 235 can be processor-executable instructions that can be executed by a dedicated or shared processor using received inputs.

In embodiments, components/functionalities of the DCMS 205 can be distributed across different computing components and/or resources over network 250. For example, each individual component and/or combinations of components depicted in FIG. 2 can be implemented as microservices. As another example, components and/or combinations thereof depicted in FIG. 2 can be containerized to bundle related applications and dependencies together for distribution over network 250.

The event data receiver 210 can be configured to obtain event data 280 of content being displayed within (e.g., accessed from) a user's environment. In embodiments, the event data 280 can be obtained in real-time (e.g., while it is being displayed to a user or is otherwise transmitted to a user device) from a source (e.g., a streaming source or data store). In embodiments, the event data 280 can be obtained in advance of it being transmitted or displayed to a user (e.g., during a buffering window or upon determining content a user will view in the future, such as a programming guide). The event data 280 can be associated with live streamed content (e.g., live sporting events) and videos (e.g., stored and accessed audio/video (A/V) data). As discussed herein, “accessing” multi-media content to obtain event data can refer to accessing multi-media content that is currently opened, currently displayed, or is predicted to be displayed in the future. Thus, the accessed multi-media content does not necessarily have to be displayed on a display or window, but rather can be accessed in a minimized or closed state.

Event data 280 includes audio and/or video data associated with accessed multi-media content. For example, with respect to a live streamed sports event, event data can include A/V data associated with the live streamed sports events, such as sports actions that occur within the sports events (e.g., live plays within a match or game), commentary on the sports event, advertisements being played during the sports event, audience reactions to the sports events (e.g.,. crowd cheering), interviews within the sports events, and metadata (e.g., time and location), among other potential events. As another example, with respect to a live streamed video, event data 280 can include A/V data associated with the live streamed video, such as the dialogue and/or events that are occurring within the live streamed video. In embodiment, event data 280 can include data associated with external sources (e.g., social media feeds) that relate to multi-media content events. For example, event data 280 can also include engagement data on social media platforms that relates to particular multi-media content items, such as likes, shares, views, and user reactions (e.g., comments on multi-media events, including sentiment associated therewith). Event data 280 can be obtained by the DCMS 205 for the purpose of issuing display reconfiguration actions.

In embodiments, event data 280 can include any suitable type of data that is available for analysis for a given item of multi-media content. For example, if visual data is not available for a particular item of multi-media content (e.g., a weather broadcast), but audio data is, then audio data can be utilized for the purpose of display configuration management without considering visual data. As another example, if audio data is not available for a particular item of multi-media content, but visual data is, then the visual data can be utilized for the purpose of display configuration management without considering audio data. Thus, event data 280 can include one or more of audio data associated with multi-media content, video data associated with multi-media content, and/or external sources describing multi-media content (e.g., social media engagements).

The user data receiver 215 can be configured to obtain user data 285 associated with users viewing content on multiple displays/windows. User data 285 can include viewing preferences of a user, such as their interests (e.g., favorite sports, genres of content, etc.), ad-viewing preferences, viewing history (e.g., pieces of content historically consumed by the user), as well as display configuration preferences (e.g., where different priority multi-media content is historically displayed within the user's environment). User data 285 can also include information about the user, such as their location and age. User data 285 can be obtained by the DCMS 205 for the purpose of issuing display reconfiguration actions. In embodiments, users opt-in to the functionalities of the DCMS 205 and provide input regarding their preferences and/or information they desire to share with the DCMS 205 for the purpose of managing display configuration.

The event data analyzer 220 can be configured to analyze event data 280 associated content 260 and 270 playing on devices 255 and 265. Analyzing event data 280 can include analyzing a time window (e.g., a current time window, such as the last 10 seconds, 30 seconds, 1 minute, etc.) associated with content items the user is viewing. In embodiments, the content ranker 227 can be configured to generate a significance score for each time window associated with each item of content the user is viewing. As referenced herein, an “item of content” refers to a particular instance of content (e.g., a sports game, a television show, a movie, a news report, a weather report, a web-based multi-media video, etc.) the user is viewing or has open. As referenced herein, a “significance score” refers to a relative importance of an instance of multi-media content, which may be represented numerically (e.g., a significant score of 100 may be a maximum significance score while a significant score of 0 may be a minimum significant score). As an example, if a particularly important event is occurring within a sports game (e.g., the last 30 seconds of a basketball match with a tied score), a relatively high significance score can be associated with the sports game. In embodiments, the significance score can further depend on user data 285 (e.g., a user with a high interest in basketball may have higher significance scores for events that occur within basketball games as compared to other types of content).

The event data analyzer 220 can be configured to ingest A/V data associated with individual items of content such that event data 280 analysis can be completed. The event data analyzer 220 can be configured to perform a plurality of natural language processing (NLP) and video content analysis (VCA) techniques to pre-process, parse, and analyze event data 280 from content. Such analyses can implement machine learning (ML) techniques. For example, the event data analyzer 220 can be configured to perform speech recognition (e.g., speech to text), speech segmentation, word segmentation, lemmatization, part-of-speech tagging, stemming, syntactical analysis, semantic analysis, named entity recognition, entity linking, discourse analysis, auto summarization, and the like on audio data and/or textual data within content. Further, the event data analyzer 220 can be configured to perform video content analysis on displayed content items, including, but not limited to, object detection, object recognition, video tracking, object co-segmentation, and activity recognition. In embodiments, the above referenced analysis techniques are performed on specific time windows of content.

In embodiments, the event data analyzer 220 can be configured to analyze external sources associated with multi-media content. For example, the event data analyzer 220 can be configured to analyze social media engagement associated with multi-media content items, such as likes, shares, views, and reactions (e.g., comments and discussion surround events that occur within multi-media content items). For example, event data analyzer 220 can be configured to analyze textual messages (e.g., user comments), images (e.g., memes or reactionary images), and/or videos (e.g., analysis videos or reaction videos) that relate to displayed multi-media content items. Such external sources can be analyzed using machine learning, NLP, and/or VCA.

The user data analyzer 225 can be configured to analyze user data 285 with respect to events to aid the content ranker 227 in generating significance scores for specific time windows of content. For example, the user data analyzer 225 can be configured to analyze user data 285 with respect to time windows of events to enable generation of significance scores that match user preferences. As such, the event data analyzer 220 and user data analyzer 225 can cooperatively process event data 280 and user data 285 such that content ranker 227 can generate significance scores for time windows of content. Thus, the significance scores generated by content ranker 227 can be based on user preferences/data and the significance of events that are occurring within content items.

In embodiments, the significance scores generated by content ranker 227 based on the event data analyzer 220 and user data analyzer 225 analyses are associated with specific time windows of content being displayed. For example, if four items of content 260 are displayed to a user on device 255, then four significance scores corresponding to four respective time windows of the respective items of content 260 can be generated. The content ranker 227 can then be configured to rank the significance scores with respect to each other such that a display reconfiguration action can be determined and issued by the display reconfiguration module 230.

Significance scores can be generated intermittently, continuously, periodically, or based on any suitable condition. For example, significance scores can be generated by content ranker 227 in response to a user request, based on a high significance event occurring within a given instance of multi-media content, or within a periodic time window (e.g., every minute, every 5 minutes, every 30 minutes, etc.). Upon generation of significance scores for each multi-media item a user is viewing, the content ranker 227 can be configured to rank each item of multi-media content with respect to each other to facilitate display configuration management. For example, the content ranker 227 can be configured to rank items of multi-media content in descending order based on significance score values associated with each respect item of multi-media content.

In embodiments, time windows of items of multi-media content for which significance scores are generated based upon can differ. For example, a first multi-media content item can have a first significance score generated based on a first time window of A/V data (e.g., 30 seconds) and a second multi-media content item can have a second significance score generated based on a second time window of A/V data (e.g., 1 minute). Thus, while different time windows of multi-media content can be used to generate significance scores by the content ranker 227, the significance scores of respective multi-media content items can be used to rank the multi-media content by the content ranker 227 for display configuration management by the display reconfiguration module 230. Further, the time windows for which significance scores are generated do not necessarily have to overlap or consider the same time intervals. For example, a first multi-media content item can have a significance score generated based on a first time window of A/V data (e.g., 00:40:00-00:41:00) that does not overlap with a second time window of A/V data of a second multi-media content item (e.g., 00:42:00-00:42:30).

The significant scores generated by content ranker 227 can be based on a collective consideration of event data 280 and user data 285. Items of multi-media content that align with a user's interests and/or preferences can be assigned relatively higher significance scores than items of multi-media content that do not align with a user's interest and/or preferences. In embodiments, user data 285 does not necessarily have to be considered for the purpose of generating significance scores. That is, significance scores of multi-media content can depend solely on event data 280 analyzed by event data analyzer 220. In embodiments, significance scores generated by content ranker 227 can be completed using one or more ML models 290. Significance scores generated by content ranker 227 can also be based on external sources analyzed by event data analyzer 220, such as insights gleaned from social media websites that describe events occurring within specific items of multimedia content, which may or may not pertain to the time window for which the significance score is calculated.

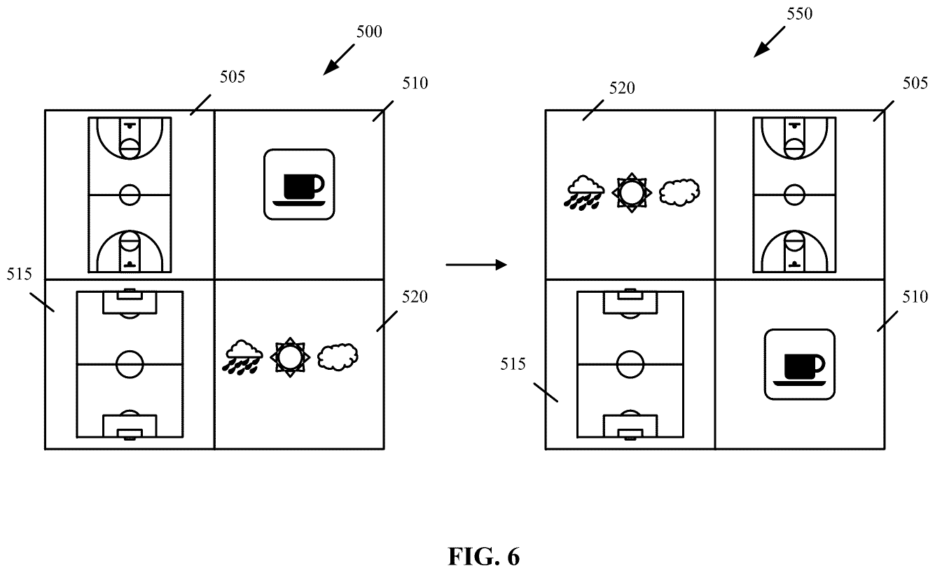

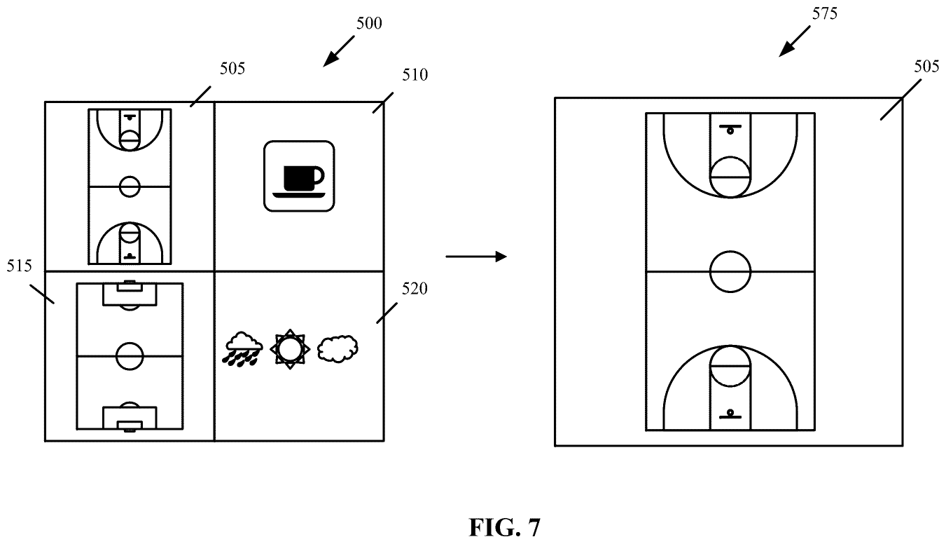

The content ranker 227 is configured to rank multiple instances of multi-media content based on the generated significance scores (e.g., which can be associated with specific time windows). The display reconfiguration module 230 can be configured to perform display reconfiguration actions based on significance score outputs produced by content ranker 227. For example, the display reconfiguration module 230 can be configured to reconfigure the size and/or locations of windows displaying content, reconfigure displays that content is displayed on, reconfigure picture-in-picture viewing of content, open new content windows and/or displays, close content windows or displays, and/or provide display reconfiguration recommendations to users, among other potential display reconfiguration actions. The display reconfiguration module 230 can be configured to reconfigure the display configuration of the user based on user preferences indicated within user data 285, which may be explicitly provided or learned over time by ML models 290. Example display reconfiguration actions are depicted in FIGS. 6-7.

ML models 290 can be used to generate significance scores for instances of multi-media content based on event data 280 and user data 285. Thus, content ranker 227 can utilize one or more ML models 290 for producing significance scores as ML model outputs 297. The ML models 290 can be trained to generate significance scores as ML model outputs 297 in a supervised, semi-supervised, or unsupervised manner. For example, in supervised learning embodiments, ML model training component 235 and/or ML model training component 295 can train ML models 290 using labeled training data. In supervised machine learning, a training dataset typically has labels for both inputs and corresponding output values. This enables the ML model to learn functions that map inputs to outputs, thereby enabling the ML model to make predictions on unseen data. As an example, ML model training components 235 and/or 295 can be configured to train ML models based on pre-labeled significance scores that correspond to specific time windows of multi-media content. In these embodiments, ML models 290 can learn from event data 280 and user data 285 that lead to particular labeled significance scores. That is, ML models 290 learn types of A/V event data 280 and associated user data 285 that lead to high significance scores and A/V event data 280 associated user data 285 that lead to low significance scores, among other magnitudes of significance scores. Thus, upon receiving new event data 280 and user data 285, ML models 290 can be configured to generate significant scores based on insights gleaned from previous iterations of supervised training.

ML models 290 can also be configured to generate significance scores in a semi-supervised or unsupervised manner, where little to no labels are associated with training data the ML models 290 learn from. Unsupervised learning enables ML models 290 to discover underlying patterns or structures (e.g., features used for predictions), such as clustering. In semi-supervised learning, a small amount of labeled data in combination with a large amount of unlabeled data can be injected during training, realizing the benefits of both supervised and unsupervised machine learning training methods.

The ML model training components 235 and/or 295 can also be configured to perform training via reinforcement learning. Within reinforcement learning frameworks, ML models 290 learn by taking actions within an environment to maximize reward. This learning typically involves trial and error, where ML agents improve their accuracy over time based on feedback (e.g., reward and punishment) they receive after each action. In embodiments, combinations of different training frameworks can be implemented into the same ML model 290. Thus, ML models 290 can be trained in a variety of manners to produce significance scores as ML model outputs 297 for time windows of multi-media content.

ML models 290 can also be used to execute display reconfiguration actions. Thus, display reconfiguration module 230 can utilize one or more ML models 290 for producing display reconfigurations as ML model outputs 297. ML models 290 can be used to execute display reconfiguration actions based on user data 285 indicating display preferences of a user. The ML models 290 can be trained to produce display reconfiguration actions as ML model outputs 297 in a supervised, semi-supervised, or unsupervised manner. As a supervised machine learning example, ML model training components 235 and/or 295 can be configured to train ML models 290 based on historical display configurations of multi-media content arrangements with corresponding pre-labeled significance scores for each respective multi-media content item. In these embodiments, ML model models 290 can learn how particular users desire to view different items of multi-media content with pre-labeled significance scores across their devices/displays/windows. That is, ML models 290 learn where high priority, medium priority, and low priority multi-media content are displayed for particular users historically within their environment. Thus, upon ascertaining significance scores for a plurality of displayed multi-media content within a given user's environment, the ML models 290 can generate a display reconfiguration action based on insights gleaned from previous iterations of supervised training. ML models 290 can also generate and execute display reconfiguration actions in semi-supervised, unsupervised, and reinforcement learning frameworks, as referenced above.

In embodiments, the display reconfiguration module 230 directly modifies a display configuration of a user (e.g., by changing locations, sizes, and devices that multi-media content are displayed on). Directly modifying a display configuration via a display reconfiguration action can include executing a command to one or more devices or displays to cause the display to be reconfigured. In embodiments, the display reconfiguration module 230 does not directly modify a display configuration of a user, but rather recommends a suggested display configuration that the user can opt to accept (e.g., enabling an automatic reconfiguration of the user's display configuration or prompting the user to manually reconfigure their display configuration) or deny. As discussed herein, executing a display reconfiguration action can include issuing, by the DCMS 205, a command causing devices 255 and 265 to perform a display reconfiguration action.

In some embodiments, the display reconfiguration module 230 can extract specific content from an item of multi-media content to superimpose onto a different item of multi-media content. For example, the display reconfiguration module 230 can be configured to extract a score, timer, caption, or other textual data from a first item multi-media content to superimpose over a location of a second item of multi-media content. This enables the user to continue viewing a particular item of multi-media content while viewing important pieces of information from a different item of multi-media content.

Though this disclosure pertains to the collection of personal data (e.g., user data 285 and/or event data 280), it is noted that in embodiments, users opt into the system. In doing so, they are informed of what data is collected and how it will be used, that any collected personal data may be encrypted while being used, that the users can opt-out at any time, and that if they opt out, any personal data of the user is deleted.

It is noted that FIG. 2 is intended to depict the representative major components of an example network environment 200. In some embodiments, however, individual components can have greater or lesser complexity than as represented in FIG. 2, components other than or in addition to those shown in FIG. 2 can be present, and the number, type, and configuration of such components can vary.

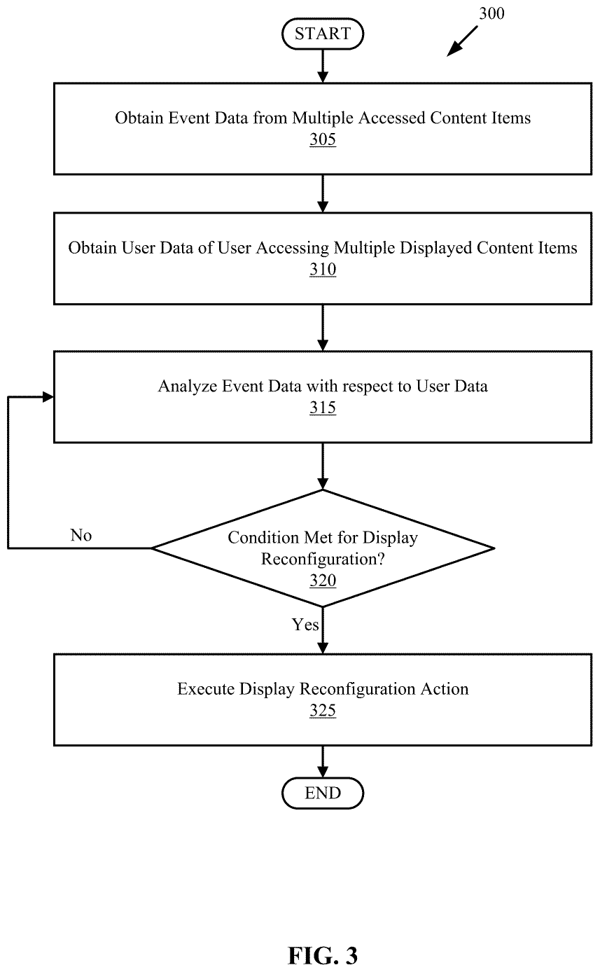

Referring now to FIG. 3, shown is a flowchart of an example method 300 for display configuration management, in accordance with embodiments of the present disclosure. One or more operations of method 300 can be completed by one or more processing circuits (e.g., computer 101, end user device 103, remote server 104, devices 255/265, DCMS 205, datastore 275, ML models 290, etc.).

Method 300 initiates at operation 305, where event data is obtained from multiple accessed content items. Obtaining event data can be completed in the same, or a substantially similar manner, as discussed with respect to the event data receiver 210 of FIG. 2. For example, event data can be obtained from multi-media content in-real time as accessed by a user or in advanced of multi-media content being played for a user (e.g., during a buffering window).

User data associated with a user accessing the multiple displayed content items is obtained. This is illustrated at operation 310. User data can be obtained in the same, or a substantially similar manner, as discussed with respect to the user data receiver 215 of FIG. 2. User data used for the purpose of display configuration management can include user preferences, ad-viewing preferences, display configuration history with respect to significance of displayed content, and other user data.

The event data is of the multiple accessed content items is analyzed with respect to the user data. This is illustrated at operation 315. Analyzing event data of multi-media content items with respect to user data can include the various analyses described with respect to the event data analyzer 220, user data analyzer 225, and content ranker 227 of FIG. 2. For example, the event data analyzer 220 can be configured to perform one or more NLP, VCA, and/or ML techniques to pre-process, parse, and analyze event data (e.g., informative data indicating descriptions of what is occurring within an item of multi-media content within a specific time window) with respect to user data (e.g., user multi-media content preferences, user ad-viewing preferences, and other user data) such that significance scores can be generated for respective items of multi-media content. As discussed with respect to FIG. 2, in embodiments, ML models 290 can be configured to generate significance scores for respective items of multi-media content based on event data 280 and user data 285.

A determination is made whether a condition is met for display reconfiguration. This is illustrated at operation 320. Determining whether a condition is met for display reconfiguration can include determining whether a current display configuration of a user matches a determined display configuration for the user based on the generated significance scores. In embodiments, as discussed with respect to FIG. 2, determining the display configuration can be completed by one or more ML models 290 based on historical display configurations the user utilizes for viewing content.

If a condition is met for display reconfiguration (“Yes” at operation 320), then a display reconfiguration action is executed. This is illustrated at operation 325. Various display reconfiguration actions can be executed. The display reconfiguration actions can include any display reconfiguration actions discussed with respect to the display reconfiguration module 230 of FIG. 2.

If a condition is not met for display reconfiguration (“No” at operation 320), then method 300 can return to operation 315, where event data can continue to be analyzed with respect to user data to determine whether any conditions are met for display reconfiguration in the future.

The aforementioned operations can be completed in any order and are not limited to those described. Additionally, some, all, or none of the aforementioned operations can be completed, while still remaining within the spirit and scope of the present disclosure. For example, in embodiments, operation 310 may not be completed in instances where user data is not considered for the purpose of display configuration management.

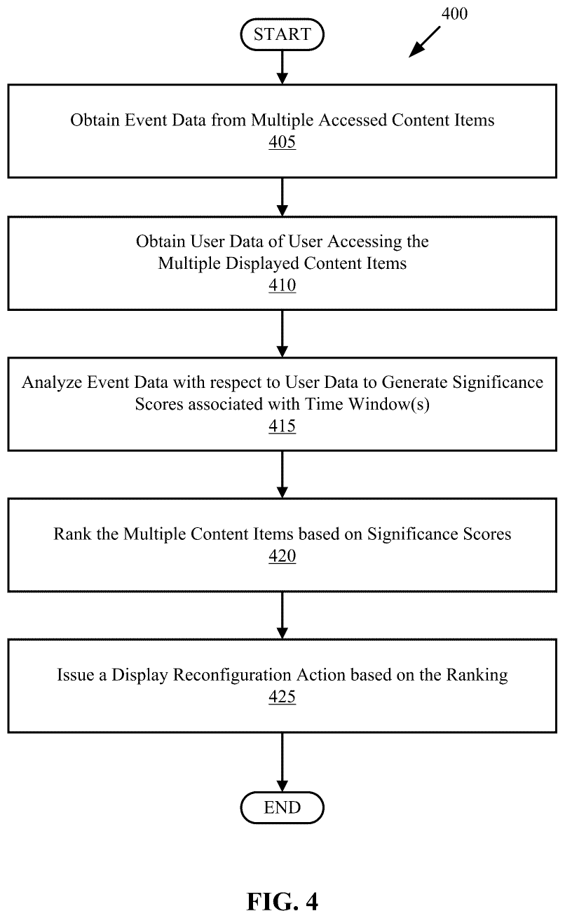

Referring now to FIG. 4, shown is a flowchart of another example method 400 for display configuration management, in accordance with embodiments of the present disclosure. One or more operations of method 400 can be completed by one or more processing circuits (e.g., computer 101, end user device 103, remote server 104, devices 255/265, DCMS 205, datastore 275, ML models 290, etc.).

Method 400 initiates at operation 405, where event data is obtained from multiple accessed content items. Obtaining event data can be completed in the same, or a substantially similar manner, as discussed with respect to the event data receiver 210 of FIG. 2. For example, event data can be obtained from multi-media content in-real time as accessed by a user or in advanced of multi-media content being played for a user (e.g., during a buffering window).

User data associated with a user accessing the multiple displayed content items is obtained. This is illustrated at operation 410. User data can be obtained in the same, or a substantially similar manner, as discussed with respect to the user data receiver 215 of FIG. 2. User data used for the purpose of display configuration management can include user preferences multi-media content viewing preferences, ad-viewing preferences, display configuration history with respect to significance of displayed content, and other user data.

The event data is of the multiple accessed content items is analyzed with respect to the user data to generate significance scores associated with specific time windows of respective multi-media content items. This is illustrated at operation 415. Analyzing event data of multi-media content items with respect to user data can include the various analyses described with respect to the event data analyzer 220, user data analyzer 225, and content ranker 227 of FIG. 2. For example, the event data analyzer 220 can be configured to perform one or more NLP, VCA, and/or ML techniques to pre-process, parse, and analyze event data with respect to user data such that significance scores can be generated for time windows of respective items of multi-media content. As discussed with respect to FIG. 2, in embodiments, ML models 290 can be configured to generate significance scores for time windows of respective items of multi-media content based on event data 280 and user data 285. The time windows used to generate significance scores can differ in length and do not necessarily have to overlap with the same time intervals.

The multiple multi-media content items are then ranked with respect to each other based on the significance scores generated at operation 415. This is illustrated at operation 420. For example, multi-media content items can be ranked in descending order of significance scores.

A display reconfiguration action is then executed based on the ranking. This is illustrated at operation 425. Various display reconfiguration actions can be executed. The display reconfiguration actions can include any display reconfiguration actions discussed with respect to the display reconfiguration module 230 of FIG. 2. In embodiments, as discussed with respect to FIG. 2, the display reconfiguration action can be determined by one or more ML models 290 based on historical display configurations the user utilizes for viewing content. The display reconfiguration action can re-order or otherwise arrange items of multi-media content within the user's environment based on the rankings determined at operation 420.

The aforementioned operations can be completed in any order and are not limited to those described. Additionally, some, all, or none of the aforementioned operations can be completed, while still remaining within the spirit and scope of the present disclosure. For example, in embodiments, operation 410 may not be completed in instances where user data is not considered for the purpose of display configuration management.

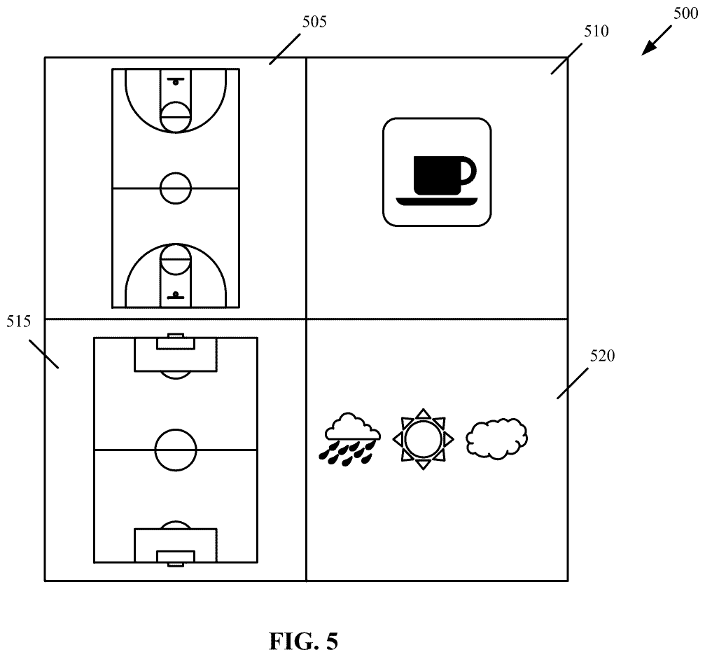

Referring now to FIG. 5, shown is a first display configuration 500 of a first display, in accordance with embodiments of the present disclosure. The first display configuration 500 includes four windows displayed on the first display. In particular, a first display window 505 displays a basketball game, a second display window 510 displays an advertisement for a beverage, a third display window 515 displays a soccer game, and a fourth display window 520 displays a weather forecast. Event data associated with each respective display window 505, 510, 515, and 520 can be analyzed using techniques described with respect to the event data analyzer 220 to pre-process, parse, and analyze descriptive information occurring within the respective items of multi-media content within each respective window. The analysis of event data can be completed for specific time window of the multi-media content such that significance scores can be generated and associated with specific time windows of the respective items of multi-media content. Generated significance scores and/or the first display configuration 500 can be used as training data for ML models 290.

Referring now to FIG. 6, shown is a display reconfiguration action that alters the first display configuration 500 to a second display configuration 550, in accordance with embodiments of the present disclosure. The first display configuration 500 includes the same multi-media content displayed in respective display windows 505, 510, 515, and 520 discussed with respect to FIG. 5. Upon generating the significance scores for respective time windows of the multi-media content, a display reconfiguration action can be determined based on the significance scores. In this example, the fourth display window 520 displaying the weather forecast has a highest significance score and is positioned in an upper left corner, the first display window 505 displaying the basketball game has a second highest significance score and is positioned in an upper right corner, the third display window 515 displaying the soccer game has a third highest significance score and is positioned in a lower left corner, and the second display window 510 displaying the beverage advertisement has a lowest significance score and is positioned in a lower right corner. Thus, the first display configuration 500 is modified to generate the second display configuration 550. Ordering content in a clockwise fashion based on significance scores can be completed due to the user historically using a similar format when viewing multi-media content.

As discussed with respect to FIG. 2, the display reconfiguration action can be learned based on how the user historically arranges multi-media content based on significance. As also discussed with respect to FIG. 2, in embodiments, the display configuration can be directly modified (e.g., automatically altered from the first display configuration 500 to the second display configuration 550 without user intervention). In embodiments, the display configuration can be recommended to a user such that the user can opt to accept the recommended display configuration (e.g., prompting the user to accept automatic display reconfiguration or perform a manual display reconfiguration).

Referring now to FIG. 7, shown is another display reconfiguration action that alters the first display configuration 500 to a third display configuration 575, in accordance with embodiments of the present disclosure. The first display configuration 500 includes the same multi-media content displayed in respective display windows 505, 510, 515, and 520 discussed with respect to FIG. 5. Upon generating the significance scores for respective time windows of the multi-media content, a display reconfiguration action can be determined based on the significance scores. In this example, the display reconfiguration action minimizes or closes the second display window 510, third display window 515, and fourth display window 520 and maximizes the first display window 505. Thus, the first display configuration 500 is modified to generate the third display configuration 575.

As discussed with respect to FIG. 2, the display reconfiguration action can be learned based on how the user historically arranges content based on significance. As also discussed with respect to FIG. 2, in embodiments, the display configuration can be directly modified (e.g., automatically altered from the first display configuration 500 to the second display configuration without user intervention). In embodiments, the display configuration can be recommended to a user such that the user can opt to accept the recommended display configuration (e.g., prompting the user to accept automatic display reconfiguration or perform a manual display reconfiguration).

In this example, the event data associated with the multi-media content in the first window may be highly significant (e.g., the last minute of the basketball game) and the user data may indicate that the user has a high interest in basketball games. Further, in similar situations, the user may close/minimize all other windows and maximize the high significance window. Thus, the determined display reconfiguration action may be the third display configuration 575 (e.g., as determined by ML models 290).

It is noted that the example display configurations of FIGS. 5-7 are merely exemplary. Any suitable number of windows and/or displays can be implemented. Further, any suitable type of multi-media content can be displayed and is not limited to the described examples. Further still, the display reconfiguration actions depicted in FIGS. 6-7 are also exemplary. Any suitable display reconfiguration actions contemplated herein can be implemented without departing from the spirit and scope of the present disclosure.

As discussed in more detail herein, it is contemplated that some or all of the operations of some of the embodiments of methods described herein may be performed in alternative orders or may not be performed at all; furthermore, multiple operations may occur at the same time or as an internal part of a larger process.

The terminology used herein is for the purpose of describing particular embodiments only and is not intended to be limiting of the various embodiments. As used herein, the singular forms “a,” “an,” and “the” are intended to include the plural forms as well, unless the context clearly indicates otherwise. It will be further understood that the terms “includes” and/or “including,” when used in this specification, specify the presence of the stated features, integers, steps, operations, elements, and/or components, but do not preclude the presence or addition of one or more other features, integers, steps, operations, elements, components, and/or groups thereof. In the previous detailed description of example embodiments of the various embodiments, reference was made to the accompanying drawings (where like numbers represent like elements), which form a part hereof, and in which is shown by way of illustration specific example embodiments in which the various embodiments may be practiced. These embodiments were described in sufficient detail to enable those skilled in the art to practice the embodiments, but other embodiments may be used and logical, mechanical, electrical, and other changes may be made without departing from the scope of the various embodiments. In the previous description, numerous specific details were set forth to provide a thorough understanding the various embodiments. But, the various embodiments may be practiced without these specific details. In other instances, well-known circuits, structures, and techniques have not been shown in detail in order not to obscure embodiments.

Different instances of the word “embodiment” as used within this specification do not necessarily refer to the same embodiment, but they may. Any data and data structures illustrated or described herein are examples only, and in other embodiments, different amounts of data, types of data, fields, numbers and types of fields, field names, numbers and types of rows, records, entries, or organizations of data may be used. In addition, any data may be combined with logic, so that a separate data structure may not be necessary. The previous detailed description is, therefore, not to be taken in a limiting sense.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Advantages discussed in the present disclosure are example advantages, and embodiments of the present disclosure can exist that realize all, some, or none of any of the discussed advantages while remaining within the spirit and scope of the present disclosure.

Although the present disclosure has been described in terms of specific embodiments, it is anticipated that alterations and modification thereof will become apparent to those skilled in the art. Therefore, it is intended that the following claims be interpreted as covering all such alterations and modifications as fall within the true spirit and scope of the disclosure.

1. A computer-implemented method comprising:
training a machine learning (ML) model using training data comprising historical display configurations of multi-media content arrangements of a user and corresponding significance scores for respective multi-media content items, wherein the machine learning model is configured to automatically execute display reconfiguration actions based on significance scores for respective multi-media content items;
analyzing event data obtained from multiple accessed multi-media content items with respect to user data of the user to generate a significance score for respective ones of the multiple accessed multi-media content items, wherein the significance scores are generated for specific time windows of respective multi-media content items; and
automatically executing, using the trained ML model and based on the significance scores, a display reconfiguration action that causes a display window displaying one of the multiple accessed multi-media content items to move from a first display location to a second display location.

2. The computer-implemented method of claim 1, wherein the significance scores generated for specific time windows of respective multi-media content items of the multiple accessed multi-media content items are determined by a second ML model.

3. The computer-implemented method of claim 2, wherein the second ML model is trained using supervised learning based on event data of historical multi-media content items and user data of the user viewing the historical multi-media content items, wherein historical multi-media content items used as training data for supervised learning have pre-labeled significance scores.

4. (canceled)

5. (canceled)

6. (canceled)

7. The computer-implemented method of claim 1, wherein the display reconfiguration action further causes one or more devices of the user to alter a display size for at least one of the multiple accessed multi-media content items.

8. A system comprising:
a processor set;
one or more computer readable storage media; and
program instructions stored on the one or more computer readable storage media to cause the processor set to perform operations comprising:
training a machine learning (ML) model using training data comprising historical display configurations of multi-media content arrangements of a user and corresponding significance scores for respective multi-media content items, wherein the machine learning model is configured to automatically execute display reconfiguration actions based on significance scores for respective multi-media content items;
analyzing event data obtained from multiple accessed multi-media content items with respect to user data of the user to generate a significance score for respective ones of the multiple accessed multi-media content items, wherein the significance scores are generated for specific time windows of respective multi-media content items; and
automatically executing, using the trained ML model and based on the significance scores, a display reconfiguration action that causes a display window displaying one of the multiple accessed multi-media content items to change from a first display size to a second display size.

9. The system of claim 8, wherein the significance scores generated for specific time windows of respective multi-media content items of the multiple accessed multi-media content items are determined by a second ML model.

10. The system of claim 9, wherein the second ML model is trained using supervised learning based on event data of historical multi-media content items and user data of the user viewing the historical multi-media content items, wherein historical multi-media content items used as training data for supervised learning have pre-labeled significance scores.

11. (canceled)

12. (canceled)

13. The system of claim 8, wherein executing the display reconfiguration action further causes one or more devices of the user to alter a display location for at least one of the multiple accessed multi-media content items.

14. The system of claim 8, wherein automatically executing the display reconfiguration action comprises:
causing one or more devices of the user to display a recommendation identifying the display reconfiguration action; and
in response to receiving a user acceptance of the recommendation, causing the one or more devices to execute the display reconfiguration action.

15. A computer program product comprising:
one or more computer readable storage media; and
program instructions collectively stored on the one or more computer readable storage media to perform operations comprising:
training a machine learning (ML) model using training data comprising historical display configurations of multi-media content arrangements of a user and corresponding significance scores for respective multi-media content items, wherein the machine learning model is configured to automatically execute display reconfiguration actions based on significance scores for respective multi-media content items;
analyzing event data obtained from multiple accessed multi-media content items with respect to user data of the user to generate a significance score for respective ones of the multiple accessed multi-media content items, wherein the significance scores are generated for specific time windows of respective multi-media content items; and
automatically executing, using the trained ML model and based on the significance scores, a display reconfiguration action that causes a display window displaying one of the multiple accessed multi-media content items to close.

16. The computer program product of claim 15, wherein the significance scores generated for specific time windows of respective multi-media content items of the multiple accessed multi-media content items are determined by a second ML model.

17. The computer program product of claim 16, wherein the second ML model is trained using supervised learning based on event data of historical multi-media content items and user data of the user viewing the historical multi-media content items, wherein historical multi-media content items used as training data for supervised learning have pre-labeled significance scores.

18. (canceled)

19. (canceled)

20. The computer program product of claim 15, wherein executing the display reconfiguration action further causes one or more devices of the user to alter a display location for at least one of the multiple accessed multi-media content items.

21. The computer-implemented method of claim 1, wherein analyzing the event data comprises:
performing, on audio/video (A/V) data within the specific time windows, one or more analysis operations selected from the group consisting of speech recognition, semantic analysis, object detection, object recognition, video tracking, object co-segmentation, and activity recognition; and
generating the significance scores based on outputs of the one or more analysis operations and the user data.

22. The computer-implemented method of claim 1, wherein automatically executing the display reconfiguration action further comprises:
extracting textual content from a second one of the multiple accessed multi-media content items; and
superimposing the textual content over the display window moved from the first display location to the second display location.

23. The computer-implemented method of claim 1, wherein automatically executing the display reconfiguration action comprises:
determining that a current display configuration differs from a display configuration corresponding to the display reconfiguration action; and
moving the display window from the first display location to the second display location in response to determining that the current display configuration differs from the display configuration corresponding to the display reconfiguration action.

24. The system of claim 8, wherein executing the display reconfiguration action comprises issuing, to a device rendering the display window, a command that causes the device to change the display window from the first display size to the second display size.

25. The system of claim 8, wherein the specific time windows comprise:
a first time window having a first duration and corresponding to a first one of the multiple accessed multi-media content items; and
a second time window having a second duration different from the first duration and corresponding to a second one of the multiple accessed multi-media content items.

26. The computer program product of claim 15, wherein automatically executing the display reconfiguration action further comprises maximizing a second display window displaying a second one of the multiple accessed multi-media content items having a higher significance score than the significance score of the multi-media content item displayed by the display window that is caused to close.

27. The computer program product of claim 15, wherein analyzing the event data comprises:
analyzing engagement data obtained from an external data source and associated with the multiple accessed multi-media content items, the engagement data comprising data selected from the group consisting of view data, sharing data, and reaction data; and
generating the significance scores based further on the engagement data.
